(19) United States
(12) Patent Application Publication
(10) Pub. No.: US 2012/0154410 A1
(43) Pub. Date: Jun. 21, 2012

(54) APPARATUS AND METHOD FOR PROCESSING A FRAME IN CONSIDERATION OF THE PROCESSING CAPABILITY AND POWER CONSUMPTION OF EACH CORE IN A MULTICORE ENVIRONMENT

(76) Inventors: Hyun-Ki Baik, Seongnam-si (KR); Hee-Jin Chung, Seoul (KR); Gyong-Jin Joung, Yongin-si (KR); Jae-Won Kim, Hwaseong-si (KR)

(21) Appl. No.: 13/310,897

(22) Filed: Dec. 5, 2011

(30) Foreign Application Priority Data
Dec. 20, 2010 (KR) 10-2010-0130880

(51) Int. Cl. G06F 15/16; G06F 13/14

(52) U.S. Cl. 345/502; 345/520

(57) ABSTRACT

An apparatus and method for processing a frame in consideration of processing capability and power consumption for each core in a multi-core system are provided. To perform a user interface drawing in a multi-core environment, an optimum combination of hardware components capable of operating with the minimum of power consumption while satisfying a requirement of a user may be obtained and a parallel user interface drawing may be performed by use of the optimum combination of hardware components.

### CROSS-REFERENCE TO RELATED APPLICATION

This application claims the benefit under 35 U.S.C. §119(a) of Korean Patent Application No. 10-2010-0130880, filed on Dec. 20, 2010, in the Korean Intellectual Property Office, the entire disclosure of which is incorporated herein by reference for all purposes.

### BACKGROUND

1. Field

The following description relates to a technique that is capable of enhancing the efficiency of processing a user interface (UI) in a multi-core environment, and more particularly, to a technology that is capable of operating a plurality of UI processing cores with reduced power consumption.

2. Description of the Related Art

When a draw process is performed to generate a display on a user interface (UI) through a parallelization of operations, hardware for a drawing operation is initially allocated such that a frame is divided for each hardware, the frame for each hardware is allocated for each area, and each area is processed at the same time. In this example, a load required for a draw process is not identified. Accordingly, even though a plurality of additional hardware components are available for use in the parallelization of operations, the same combination of initially allocated hardware components are used each time a frame is processed.

If a drawing process of an input frame requires a high computation quantity, it may be difficult to satisfy a desired response time even if each of the initially allocated hardware components are used. On the contrary, if a drawing process of an input frame requires a low computation quantity, the desired response time may be obtained, however, unnecessary hardware components may be operating, resulting in an increase of power consumption.

### SUMMARY

In one general aspect, there is provided an apparatus for processing a frame to be displayed on a user interface in consideration of processing capability and power consumption for each core in a multi-core system, the apparatus including a load calculation unit configured to calculate a load used to process each respective operation from a plurality of operations included in the frame, based on the operation type and the size of a view area of the respective operation, and a core selecting unit configured to select a core to process a respective operation from among a plurality of cores existing on the multi-core system, based on the calculated of the operation type of the respective operation, and the processing capabilities and power consumptions of the cores.

The apparatus may further comprise a storage unit configured to store the plurality of operations forming the frame in a consecutive order.

The apparatus may further comprise a frame generating unit configured to generate the frame that is to be displayed on the user interface, by processing each respective operation at the respective core selected for the processing the respective operation.

The core selecting unit may select a core from at least one of a plurality of central processing units (CPU) and a plurality of graphic processing units (GPU) that exist in the multi-core system as a core to process the operation.

The core selecting unit may comprise information about an operation processed at each core existing in the multi-core system, a number of pixels of the operation processed for a predetermined amount of time, and a power consumption used to process a predetermined number of pixels.

In another aspect, there is provided a method for processing a frame to be displayed on a user interface in consideration of processing capability and power consumption for each core in a multi-core system, the method including receiving a plurality of operations that form a frame to be displayed on a user interface and storing the received plurality of operations in a consecutive order, calculating a load that is used to process each respective operation based on the operation type and view size area of the respective operation, selecting a core for each respective operation that has a minimum power consumption used to display the respective operation of the frame from among respective cores existing on the multi-core system, based on the calculated load for the respective operation, processing capabilities of the respective cores, and power consumptions of the respective cores, and generating the frame that is to be displayed on the user interface, by processing each respective operation at the respective core selected to process the respective operation.

The calculating of each load may comprise quantifying each load based on the operation type of the operation and a number of pixels of the view area, and the quantified loads may be divided based on the operation types of the respective operations such that the loads of the system are the same in number as the number of the operation types of the operations forming the frame.

The selecting of the core may comprise, if the operations forming the frame are to be processed only at one core of the cores existing in the multi-core system, selecting the one core, determining whether the selected core has the ability to handle the loads of all the operations forming the frame, if a result of the determination is that the selected core does not have the ability to handle the loads of all the operations, selecting an additional core that has a minimum power consumption used to display the frame from among the respective cores existing on the multi-core system, based on the processing capabilities and power consumptions of the respective cores, determining whether the selected cores have the ability to handle the loads of all the operations forming the frame, and if a result of the determination is that the selected cores have the ability to handle the load of all the operations forming the frame, allocating the selected cores such that the operations are processed through the selected cores.

In the selecting of the one core, all of the operations forming the frame may be searched, and if an operation of the operations forming the frame is processed only at one core of the cores existing in the multi-core system, the one core may be selected as a core to process the operation.

The determining the ability to handle all of the loads may comprise comparing the processing capability of the selected core with a total load that is obtained by adding up the loads for each operation type of the operations, and if the processing capability of the selected core is lower than the total load, the selected core may be determined to not have the ability to handle the loads.

The selecting of the additional core may comprise calculating a capability value of each core existing in the multicore-system based on a number of pixels of the operation which are processed for each core over a predetermined amount of time and a power consumption for each core used to process a predetermined number of pixels, and selecting a core having a maximum capability value or a minimum capability value from among the cores existing in the multicore-system.

The method may further comprise repeating the selecting an additional core having a minimum power consumption used to process the operations based on the processing capabilities and power consumptions of the cores existing in the multi-core system, if a result of the determination is that the selected cores does not have the ability to handle the loads of all of the operations forming the frame.

In another aspect, there is provided an apparatus for processing and displaying an image comprising a plurality of objects, the apparatus including a plurality of cores for processing the image, a load calculation unit to calculate a load that is used to process each object of the image based on the operation type and the view size of each object, and a core selector to select a core for processing each respective object, based on the calculated load to process the respective object, and the processing capabilities and power consumptions of the plurality of processing cores.

The apparatus may further comprise a user interface (UI) to display the result of the processed image.

The core selector may select a first core to process a first object, and select a second core to process a second object.

The core selector may select a core that uses the least amount of power consumption to process a first object, as the core to process the first object.

One or more of the plurality of the objects may comprise a video image.

Other features and aspects may be apparent from the following detailed description, the drawings, and the claims.

### BRIEF DESCRIPTION OF THE DRAWINGS

FIG. 1 is a diagram illustrating an example of a hierarchy tree forming a frame.

FIG. 2 is a diagram illustrating an example of a view hierarchy forming a frame that is displayed on a terminal.

FIG. 3 is a diagram illustrating an example of a frame processing apparatus.

FIG. 4 is a diagram illustrating an example of a process for calculating a system load that is used to display a frame (Frame N).

FIG. 5A is a diagram illustrating an example of a table including processing capabilities and power consumptions that are mapped to respective cores of a system.

FIG. 5B is a diagram illustrating an example of a table representing the priority of the cores of the system based on the capability value of the cores.

FIG. 6 is a flowchart illustrating an example of a drawing process method.

FIG. 7 is a flowchart illustrating an example of a method for allocating hardware components that process operations.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

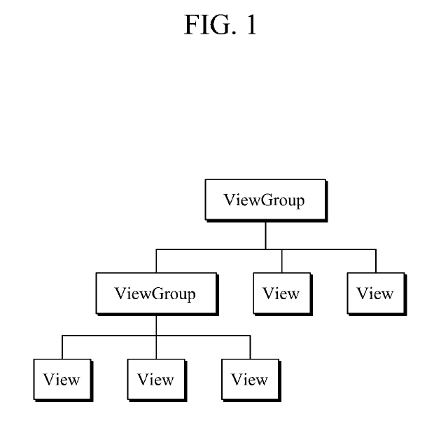

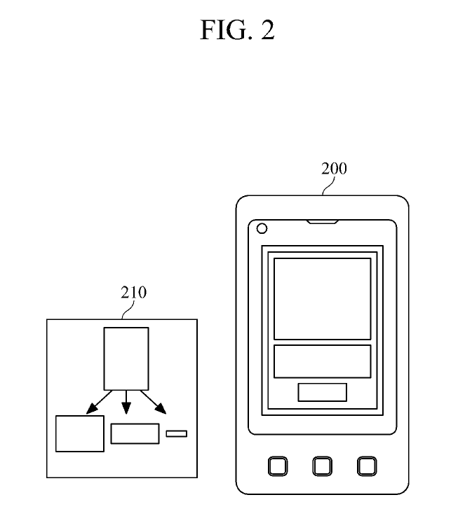

FIG. 1 illustrates an example of a view hierarchy tree forming a frame. FIG. 2 illustrates an example of a view hierarchy forming a frame that is displayed on a terminal.

In this example, the user interface of an application includes a view and view groups that each include views. The user interface may be implemented in the form of a tree.

Each view shown in FIGS. 1 and 2 may be formed by drawing hardware, for example, a central processing unit (CPU), a graphic processing unit (GPU), a two-dimensional accelerator, and the like.

The user interface may be processed by performing a layout process and a draw process. In this example, the draw process may be a more intensive job than the layout process.

The layout process may include a measure pass that is performed to determine the size of each view of the view hierarchy tree and a layout pass that is performed to determine the position and the final size of each view. The draw process may perform a draw at a corresponding area of each view based on the view hierarchy tree.

In the example illustrated in FIG. 2, the user interface is represented on a terminal as a view hierarchy 210 which includes a plurality of views. A draw process may be performed on each view, thereby displaying the entire frame.

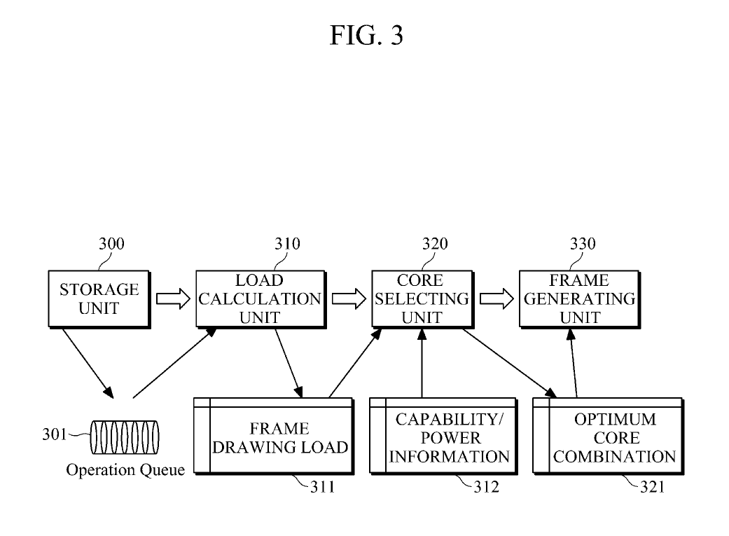

FIG. 3 illustrates an example of a frame processing apparatus.

Referring to FIG. 3, the frame processing apparatus includes a storage unit 300, a load calculation unit 310, a core selecting unit 320, and a frame generating unit 330. The frame processing apparatus 300 may be or may included in a terminal, such as a mobile terminal, a computer, a smart phone, a MP3 player, and the like.

The storage unit 300 may store operations that form a frame in an operation queue 301. For example, the storage unit 300 may store the operations that form the frame in a consecutive order.

The load calculation unit 310 may calculate loads that are used to process the operations in a system. For example, the load calculation unit 310 may calculate a load for each type of the operations by referring to the types and view areas of the operations that form the frame and that are to be displayed on a user interface.

The core selecting unit 320 may select a core that has a minimum power consumption used to display the frame from among respective cores that exist on the multi-core system. For example, the core selecting unit 320 may select a core based on the calculated loads for each operation type, processing capabilities of the respective cores, and power consumptions of the respective cores. Accordingly, a combination of selected cores for processing the frame may be determined.

The frame generating unit 330 may generate the frame that is to be displayed on the user interface, by processing the operation at the selected core using the optimum combination of cores 321.

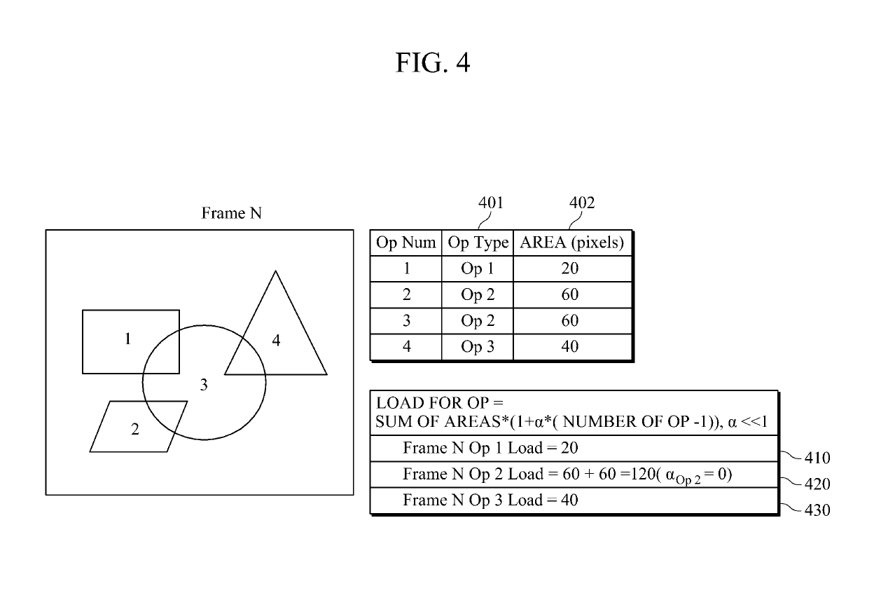

FIG. 4 illustrates an example of a process of calculating a system load that is used to display a frame (Frame N).

Referring to FIG. 4, frame N includes four operations 1, 2, 3 and 4, and loads of a system may be calculated for each operation. In the example of FIG. 4, each operation has an operation type 401 and a view area 402.

In this example, operation 1 has an operation type of Op1 and a view area of 20 pixels, operation 2 has an operation type of Op2 and a view area of 60 pixels, operation 3 has an operation type of Op2 and a view area of 60 pixels, and operation 4 has an operation type of Op3 and a view area of 40 pixels. The operation type may refer to a characteristic of operation in terms of the amount of computation. For example, ‘Op1’ may represent ‘fill’ and ‘Op2’ may represent ‘alpha blend’.

A load for each operation may be calculated for each type of the operation by an equation that is shown on top of a lower table in FIG. 4, based on the operation type and the view area of the operation. That is, a load for processing the entire frame is not calculated as a whole, but is instead calculated based on individual operations.

In FIG. 4, operation 2 has the same operation type as that of the operation 3 from among the four operations. Accordingly, three loads including a load 410 for Op1, a load 420 for Op2 and a load 430 for Op3 are calculated.

The loads to process operation 2 and operation 3 are obtained by simply summing each load for operation 2 and operation 3. The equation used to obtain the loads to process operations may be implemented in various forms based on additional information about the number of operations.

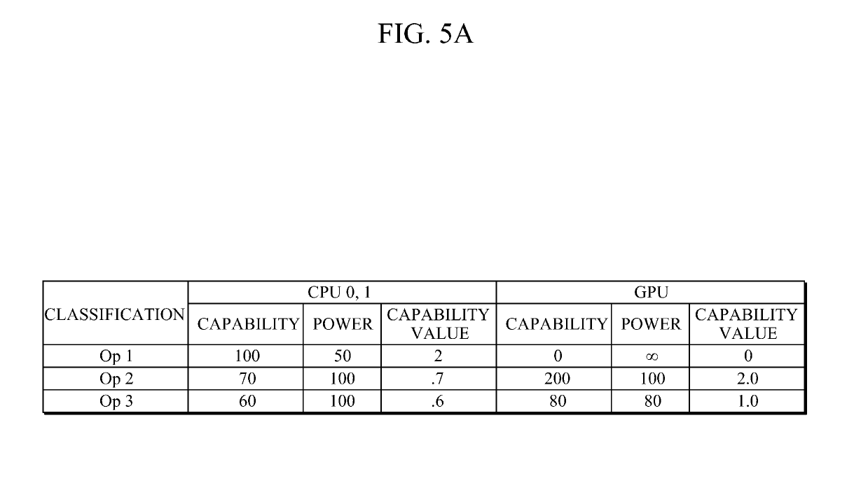

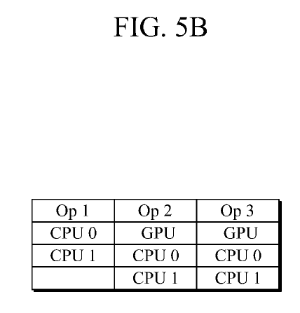

FIG. 5A illustrates an example of a table including processing capabilities and power consumptions that are mapped to respective cores of a system.

Processing capabilities and power consumptions to process operations corresponding to operation type Op1, Op2 and Op3 are calculated for each of cores CPU0, CPU1 and GPU as shown in FIG. 5A.

The processing capability represents the number of pixels that are processed for a predetermined update time, for example, 16 ms. The power consumption represents power consumption to process a drawing operation that is performed on a predetermined number of pixels, for example, 100 megapixels.

In addition, a capability value shown in FIG. 5A represents the proportion of the processing capability to power consumption. The higher the capability value the less power consumption used to process a predetermined number of pixels. Accordingly, a core having a higher capability value may be primarily selected during the processing of operations.

The processing capability, the power consumption, and the capability value may be quantified as shown in FIG. 5A based on the above definition of the processing capability, the power consumption, and the capability value. It should be appreciated however, the definition of the processing capability, the power consumption and the capability value and the quantifying thereof is not limited to the examples described herein, and may vary based on an operation policy of a system.

FIG. 5B illustrates an example of a table representing the priority among cores of a system based on the capability value of the cores.

As shown in FIG. 5A, the capability value of the GPU corresponding to operation type Op1 is ‘0’. Accordingly, it is determined that the GPU has no ability to process an operation that has the operation type Op1, and FIG. 5B shows the operation that has the operation type Op1 may be processed at CPU0 and CPU1. In this example, the CPU0 has the same capability value as that of the CPU1, resulting in no priority between the CPU0 and the CPU1.

For operation type Op2, the capability value for each of CPU0, CPU1, and GPU is not ‘0’, and so it is determined that GPU, CPU0, and CPU1 have an ability to process operation type Op2. In this example, the capability value of ‘2.0’ of GPU is higher than that the capability value of ‘0.7’ of CPU0 and CPU1. Accordingly, operation type Op2 may be processed by sequentially using GPU and CPU1 or CPU0, thereby generating a benefit in power consumption.

For operation type Op3, the capability value of the CPU0, CPU1, and the GPU is not ‘0’, and so it is determined that GPU, CPU0, and CPU1 have an ability to process operation typo Op3. In this example, the capability value of ‘1.0’ of GPU is higher than the capability value of ‘0.6’ of CPU0 and CPU1. Accordingly, operation type Op3 may be processed by sequentially using GPU and CPU1 or CPU0, thereby generating a benefit in power consumption. As described above, FIG. 5B shows the priority of cores according to each operation type of the operation.

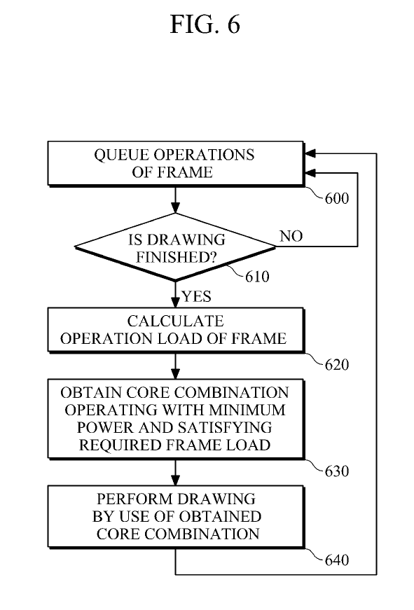

FIG. 6 illustrates an example of a drawing process method.

Referring to FIG. 6, a user interface stores the operations forming the frame in a consecutive order, in 600. For example, the operations forming the frame may be stored in a queue. A determination is made as to whether all of the operations forming the frame are stored, in 610, and the storing of the operation is repeated until all of the operations forming the frame are stored.

If the storing of the operations is finished, in 620 the loads of a system to process the operations are calculated for each operation types by referring to operation types and a view area of the stored operations.

For example, each of the loads of the system may be quantified based on the operation type of the operation and the number of pixels of the view area, and the quantified loads may be divided according to the operation type of the operations to correspond to the number of the operation types of the operations forming the frame.

A core having a minimum power consumption for displaying the frame is selected in consideration of the calculated loads for each operation type, processing capabilities of the respective cores, and power consumptions of the respective cores, in 630. If a plurality of cores are selected, the loads may be allocated to the selected cores forming a combination, respectively.

The operations are processed at the selected cores such that a frame to be displayed on the user interface is generated, in 640.

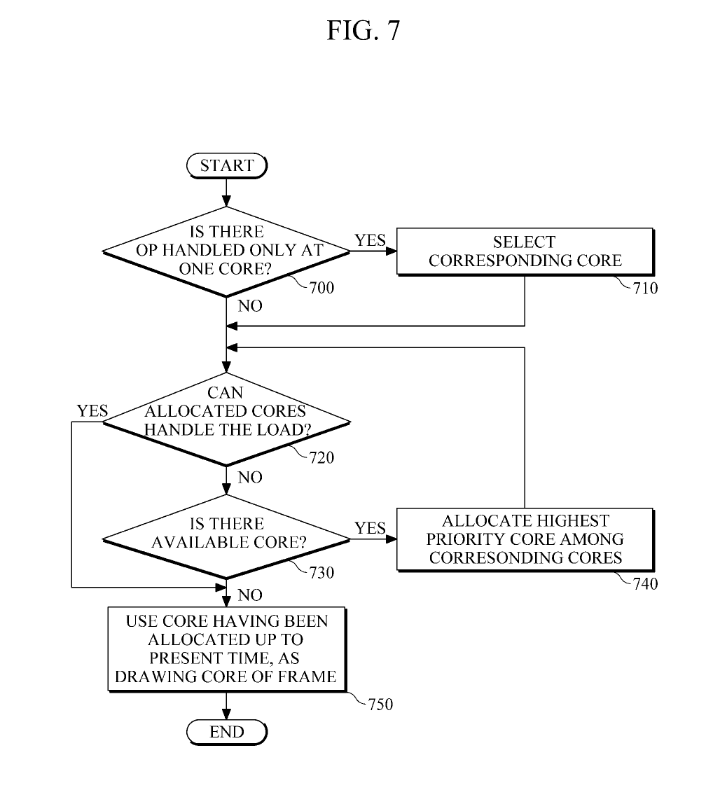

FIG. 7 illustrates an example of a method for allocating hardware components that process operations. FIG. 7 is a further description of the selecting of the core shown in FIG. 6.

If the frame is processed only at one core of the cores existing in the multi-core system, the one core is selected in 710.

That is, if all of the operations forming the frame are searched and if an operation of the operations forming the frame is processed only at one core of the cores existing in the multi-core system, the one core is selected as a core to process the operation.

A determination is made as to whether the selected core has an ability to handle the loads of all of the operations forming the frame when the operations are processed according to the consecutive order of storing the operations, in 720.

For example, the processing capability of the selected core may be compared with a total load that is obtained by performing a summation of the loads, which are calculated for each operation type of the operations. If the processing capability of the selected core is lower than the total load, the selected core may be determined to have no ability to handle the loads.

If a result of the determination is that the selected core has no ability to handle the loads of all of the operations, whether there is an additional core available to process the load is determined, in 730. If there are additional cores available to process the load, a core that has a highest priority is selected from among the cores and the selected core is additionally allocated to process the load, in 740. For example, a core using a minimum power consumption to display the frame may be selected from among the respective cores existing on the multi-core system, in 740. For example the additional core may be selected based on the processing capabilities and power consumptions of the respective cores. For example, a capability value of each core existing in the multicore-system may be calculated based on the number of pixels of an operation processed for each core and a power consumption for each core to process a predetermined number of pixels. Thereafter, a core having a maximum capability value or a minimum capability value may be selected from among the cores existing in the multicore-system as the additional core.

The operations 720, 730, and 740 may be repeated until enough cores are selected to handle the load of processing the frame.

If a result of the determination in 720 is that the selected cores have an ability to handle the load of all of the operations forming the frame, the loads are allocated such that the operations are processed through the selected cores, in 750.

Various aspects described herein are directed towards a draw processing technique that is capable of satisfying a desired response time and consuming a more optimal amount of resources by dynamically identifying the amount of computation for each input frame.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing a frame to be displayed on a user interface in consideration of processing capability and power consumption for each core in a multi-core system, the apparatus comprising:
a load calculation unit configured to calculate a load used to process each respective operation from a plurality of operations included in the frame, based on the operation type and the size of a view area of the respective operation; and
a core selecting unit configured to select a core to process a respective operation from among a plurality of cores existing on the multi-core system, based on the calculated of the operation type of the respective operation, and the processing capabilities and power consumptions of the cores.

2. The apparatus of claim 1, further comprising a storage unit configured to store the plurality of operations forming the frame in a consecutive order.

3. The apparatus of claim 1, further comprising a frame generating unit configured to generate the frame that is to be displayed on the user interface, by processing each respective operation at the respective core selected for the processing the respective operation.

4. The apparatus of claim 1, wherein the core selecting unit selects a core from at least one of a plurality of central processing units (CPU) and a plurality of graphic processing units (GPU) that exist in the multi-core system as a core to process the operation.

5. The apparatus of claim 1, wherein the core selecting unit comprises information about an operation processed at each core existing in the multi-core system, a number of pixels of the operation processed for a predetermined amount of time, and a power consumption used to process a predetermined number of pixels.

6. A method for processing a frame to be displayed on a user interface in consideration of processing capability and power consumption for each core in a multi-core system, the method comprising:
receiving a plurality of operations that form a frame to be displayed on a user interface and storing the received plurality of operations in a consecutive order;
calculating a load that is used to process each respective operation based on the operation type and view size area of the respective operation;
selecting a core for each respective operation that has a minimum power consumption used to display the respective operation of the frame from among respective cores existing on the multi-core system, based on the calculated load for the respective operation, processing capabilities of the respective cores, and power consumptions of the respective cores; and
generating the frame that is to be displayed on the user interface, by processing each respective operation at the respective core selected to process the respective operation.

7. The method of claim 6, wherein the calculating of each load comprises quantifying each load based on the operation type of the operation and a number of pixels of the view area, and the quantified loads are divided based on the operation types of the respective operations such that the loads of the system are the same in number as the number of the operation types of the operations forming the frame.

8. The method of claim 6, wherein, the selecting of the core comprises:
if the operations forming the frame are to be processed only at one core of the cores existing in the multi-core system, selecting the one core;
determining whether the selected core has the ability to handle the loads of all the operations forming the frame;
if a result of the determination is that the selected core does not have the ability to handle the loads of all the operations, selecting an additional core that has a minimum power consumption used to display the frame from among the respective cores existing on the multi-core system, based on the processing capabilities and power consumptions of the respective cores;
determining whether the selected cores have the ability to handle the loads of all the operations forming the frame, and if a result of the determination is that the selected cores have the ability to handle the load of all the operations forming the frame, allocating the selected cores such that the operations are processed through the selected cores.

9. The method of claim 8, wherein in the selecting of the one core, all of the operations forming the frame are searched, and if an operation of the operations forming the frame is processed only at one core of the cores existing in the multi-core system, the one core is selected as a core to process the operation.

10. The method of claim 8, wherein the determining the ability to handle all of the loads comprises comparing the processing capability of the selected core with a total load that is obtained by adding up the loads for each operation type of the operations, and if the processing capability of the selected core is lower than the total load, the selected core is determined to not have the ability to handle the loads.

11. The method of claim 8, wherein the selecting of the additional core comprises:
calculating a capability value of each core existing in the multicore-system based on a number of pixels of the operation which are processed for each core over a predetermined amount of time and a power consumption for each core used to process a predetermined number of pixels; and
selecting a core having a maximum capability value or a minimum capability value from among the cores existing in the multicore-system.

12. The method of claim 8, further comprising repeating the selecting an additional core having a minimum power consumption used to process the operations based on the processing capabilities and power consumptions of the cores existing in the multi-core system, if a result of the determination is that the selected cores does not have the ability to handle the loads of all of the operations forming the frame.

13. An apparatus for processing and displaying an image comprising a plurality of objects, the apparatus comprising:
a plurality of cores for processing the image;
a load calculation unit to calculate a load that is used to process each object of the image based on the operation type and the view size of each object; and
a core selector to select a core for processing each respective object, based on the calculated load to process the respective object, and the processing capabilities and power consumptions of the plurality of processing cores.

14. The apparatus of claim 13, further comprising a user interface (UI) to display the result of the processed image.

15. The apparatus of claim 13, wherein the core selector selects a first core to process a first object, and selects a second core to process a second object.

16. The apparatus of claim 13, wherein the core selector selects a core that uses the least amount of power consumption to process a first object, as the core to process the first object.

17. The apparatus of claim 13, wherein one or more of the plurality of objects comprise a video image.
